(19) United States
(12) Patent Application Publication
(10) Pub. No.: US 2008/0209579 A1
(43) Pub. Date: Aug. 28, 2008

(54) Electro-Mechanical System For Non-Duplication of Operating System

(76) Inventor: George John Thekkethil, Bangalore (IN)

Correspondence Address: Intellectual Property Dept.;Dewitt Ross & Stevens SC, 2 East Mifflin Street, Suite 600, Madison, WI, 53703-2865, US

(21) Appl. No.: 11/913,811

(22) PCT Filed: Apr. 12, 2006
(86) PCT No.: PCT/IN2006/000123

§ 371 Date: Apr. 2, 2008

(30) Foreign Application Priority Data
May 9, 2005 (IN) 543/CHE/2005

(51) Int. Cl. H04L 9/32

(52) U.S. Cl. 726/31

(57) ABSTRACT

An electromechanical system consists of a memory storage unit in which the licensed operating system is stored. The function of this device is to recognize the requested data and thereby allow the operating system from the memory storage unit according to the instructions set to this device. It is an effective means for protecting the operating system in the device from non-duplication. The operating system present in the memory storage unit is constructed as license specific.

### FIELD OF THE INVENTION

The present invention generally relates to an electronic system for non-duplication of Operating system. More particularly the present invention provides an electromechanical system useful for preventing copying of operating system into the computer. The present invention provides an electromechanical system for the installation of operating system to a computer without the need for a CD.

The present invention provides a MEMS (Micro Electro Mechanical System) based chip useful for Non-Duplication of operating systems to be installed onto a computer.

### BACKGROUND ART

Operating system is one of the most valuable technologies of the Information Age, running everything from PCs to the Internet. Yet, because operating system has become such an important productivity tool, the illegal duplication and distribution of operating system persists globally. Operating system is important to every business, government, school and consumers.

Most retail programs are licensed for use at just one computer site or for use by only one user at any time. By buying the operating system, the user becomes a licensed consumer rather than an owner. The user is allowed to make copies of the program for backup purposes, but it is against the law to give copies to friends and colleagues.

Unauthorized copying/installation of Operating system is all but impossible to stop, although operating system companies are launching more and more lawsuits against major infractors. Originally, operating system companies tried to stop unauthorized use of operating system by copy-protecting their operating system. This strategy failed, however, because it was inconvenient for users and was not 100 percent foolproof. Most operating system now requires some sort of registration, which may discourage would-be pirates, but doesn't really stop unauthorized usage of operating system.

Reference may be made to the US Publication No. 2005 0216685 A1 Heden, Donald Gene; et al, wherein it has been disclosed that:—The Intelligent Media Storage System disclosed herein protects computer programs and/or data files from being copied and used in an unauthorized manner. According to an example embodiment of the invention, an Intelligent Control Element (ICE) is installed between a computer system and a mass storage device. In a preferred embodiment, the ICE is disposed between a media storage device interface and the computer system interface. The ICE is responsible for writing data to and reading data from the protected mass storage devices of the IMSS. The ICE writes to and reads from the mass storage devices using special coding and encryption mechanisms. Each IMSS ICE uses different keys to code and encrypt data stored onto the mass storage device. Protected data is prepared for installation on an individual IMSS installed in one specific computer system, which is not usable by any other computer system (even when that other computer system is also equipped with another IMSS). In some embodiments, the mass storage interfaces are partitioned into separate protected and unprotected mass storage interfaces. In embodiments where associated interfaces are partitioned, the unprotected mass storage interfaces are controlled either directly by the system, or indirectly (as logical mass storage interfaces) by the ICE. In contrast, the protected mass storage interfaces are always physically restricted from being directly accessible from the system interface, and are generally controlled only by the ICE. In other embodiments, coding and encryption by the ICE of data stored onto protected mass storage connected to the IMSS provides another level of protection. The interface protocol implemented by the ICE is proprietary and is licensed only to operating system manufactures and distributors, which provides yet another level of protection. The use of standard mass storage read commands (i.e., non-IMSS ICE read commands) upon hard drives and devices written to by an IMSS will cause only coded and encrypted data from the protected mass storage device to be read. Although backup copies of the protected (i.e., coded and/or encrypted) files may be made, such copies are useless for any other purpose, as they will contain the coded/encrypted data that only the originating IMSS can decode or decipher. Thus, copies of protected programs and/or data files made for legitimate backup purposes cannot be used for any other purpose.

Here we can see that the data file access in IMSS (Intelligent Media Storage System) is allowed through authentication code system operating through ICE (Intelligent Control Element). ICE (Intelligent Control Element) could be attached along with Hard Drive, CD, DVD Flash Drive Etc. The Main drawback of this invention is, it allows read or write file creation, data coding, copying, deleting and encryption of files from IMSS (Intelligent Media Storage System) like any other conventional storage media. Secondly this invention works mostly only on operating system security with minimal use of hardware security.

### OBJECT OF THE INVENTION

It is thus the main object of the present invention is to provide an electromechanical system for Non-Duplication of Operating systems, which obviates the drawbacks of the prior art.

Main object of our present invention is to provide an electronic system for Non-Duplication of Operating systems, which obviates the drawbacks of the prior art.

Another object of the present invention is to provide an electromechanical system for Non-Duplication of Operating systems useful for preventing copying of files of the operating system to be installed in any computer.

Another object of the present invention is to provide an electronic system for Non-Duplication of Operating systems useful for preventing copying of files of the operating system to be installed in any computer.

Still another object of the present invention is to provide an electromechanical system for Non-Duplication of Operating system, by capturing the hardware specification of the computer for the number of licenses specified by the licenser of the Operating system.

Still another object of the present invention is to provide an electronic system for Non-Duplication of Operating system, by capturing the hardware specification of the computer for the number of licenses specified by the licenser of the Operating system.

A still further object of the present invention is to provide a MEMS based chip for Non-Duplication of Operating systems.

An object of the present invention is to provide a MEMS based chip useful for installation in a computer.

Yet another object of the present invention is to provide a MEMS based chip for installation in a desktop computer.

Still another object of the present invention is to provide a MEMS based chip for installation in a laptop.

Yet another object of the present invention is to provide a MEMS based chip for installation in a notebook.

Yet another object of the present invention is to provide a MEMS based chip for installation in a PDA.

Still further object of the present invention is to provide an electromechanical/electronic system useful for preventing the unauthorized installation of licensed operating system to a desktop computer.

Yet further object of the present invention is to provide an electromechanical/electronic system useful for preventing the unauthorized installation of licensed operating system to a laptop computer.

Yet another object of the present invention is to provide an electromechanical/electronic system useful for preventing the unauthorized installation of licensed operating system to a notebook.

Yet another object of the present invention is to provide an electromechanical/electronic system useful for preventing the unauthorized installation of licensed operating system to a PDA.

Another object of the present invention is to provide an electromechanical/electronic system useful for preventing copying of operating system files on to a desktop computer.

Still other object of the present invention is to provide an electromechanical/electronic system useful for preventing copying of operating system files on to a laptop computer.

Yet another object of the present invention is to provide an electromechanical/electronic system useful for preventing copying of operating system files on to a notebook computer.

Yet another object of the present invention is to provide an electromechanical/electronic system useful for preventing copying of operating system files on to a PDA.

### SUMMARY OF THE INVENTION

The present invention prevents copying of licensed operating system into the computer. The electromechanical system can be miniaturized to a MEMS configuration. This electromechanical system is mounted on host system, in which the operating system presents in the external memory to be installed on to the computer. This electromechanical system can replace the CDs for installation/reinstallation of operating system.

Also, there is an application programme stored in the hardware specification storage unit of the device that gathers the host information of the Ethernet card.

Thus according to the basic aspects of the present invention provides an electromechanical system for non-duplication of operating system comprises of:

a host system is one in which the system can request and receive the operating system installer file from the operating system storage zone;

the processor which compares the instructions from the instruction zone is the hardware specification storage unit of the system which is integrated on a MEMs chip;

the operating system storage zone is a memory flash, a memory flash card, a hard disk, a eprom, a eeprom, a RAM, a disc on chip.

At the non-duplicated request the operating system storage zone sends the operating system to the host system through the processor;

The above method of the present invention is adapted for non-duplication of operating system. The device comprise of a processor, controller instruction unit, switches and the hardware specification storage unit or zone, which will be integrated in a MEMS (Micro Electro Mechanical System) Chip.

Additional details of the above-described method for creating and using the electromechanical system for non-duplication of operating system are provided below:

### BRIEF DESCRIPTION OF THE DRAWINGS:

FIG. 1 shows an embodiment of the electromechanical system containing operating system for installation into a host system such as a computer, desktop, laptop, notebook and the like. (1) The host system is one in which the system can request and receive the operating system installer file from the operating system storage zone (8). (2) is the processor, which compare the instructions from the instruction zone (3). (4) is the hardware specification storage unit of the system. (5) is the controller that controls the switch (6) and switch (9) by the signal (e) and signal (i). Operating system is stored in operating system storage zone (8). There is no-information present in zone (7) and zone (10).

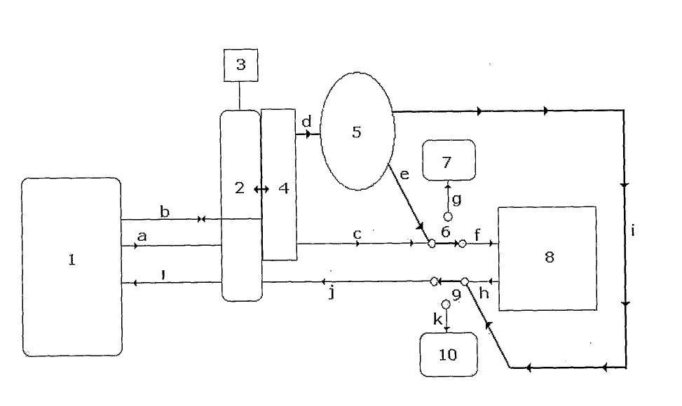

Accordingly the present invention provides a licensed operating system in an electromechanical system loadable without a CD, which comprises: a processor (2) receiving the request data (a) from the host system (1). The processor (2) compares the instructions from the instruction zone (3) and processes the requesting data (a) accordingly. During the time of processing the requested data, the (4) hardware specification storage unit requests the hardware key of the host system (1) with a request command (b). Hardware specification storage unit (4) gathers and stores the hardware key form the host system (1) of the licensee. The processed signal (d) is sent to the controller (5) and the processed data (c) is sent to the switch (6) that is controlled by the controller (5). The controller (5) thereby sends the processed signal to the switch (6). If the requested data (a) is to duplicate the operating system present in the operating system storage zone (8) the switch (6) switches to the no-information zone (7). If the requested data (a) is correct or non-duplicable of the operating system present in the operating system storage zone (8) then the switch (6) switches directly into the operating system storage zone (8). According to non-duplicated request the operating system storage zone (8) sends data back to the host system (1) through the processor (2). During the transfer of the operating system to the host system (1), if the processor (2) understands if another duplication request is requested to the processor (2) then the processor (2) sends a signal (d) to the controller (5) to turn OFF the switch (9) to a no-information zone (10) by the signal (i) from the controller (5) whereas the non-duplicated request would be allowed directly through the channel (I) into the host system (1) from the processor (2).

In an embodiment of the present invention the known operating system may be such any licensed operating system.

In still another embodiment of the present invention the system may be such as a computer.

In yet another embodiment of the present invention the computer may be such as a desktop, a laptop, a notebook, a PDA.

According to the invention, the electromechanical/electronic means functions as per the following steps:
a. The electromechanical system is mounted on a host system (1)—computer, wherein the computer may be a desktop, a laptop, a notebook, or a PDA.
b. The host system (1) sends a request data (a) to the processor (2).
c. The processor (2) compares the requested data with the instructions from the instruction zone (3).
d. The processed signal (d) is sent to the controller (5).
e. The controller (5) thereby sends the controlled signal (e) to the switch (6) to control the switch (6) in which the processed data (c) reach switch (6) from processor (2).
f. If the requested data (a) is to duplicate the audio file present in the operating system storage zone (8) the switch (6) switches to the no-information zone (7).
g. If the requested data (a) is correct or non-duplicable of the operating system present in the operating system storage zone (8) then the switch (6) switches directly into the operating system storage zone (8).
h. According to non-duplicated request the operating system storage zone (8) sends data back to the host system (1) through the processor (2).
i. During the transfer of the operating system to the host system (1), if the processor (2) understands if another duplication request is requested to the processor (2) then the processor (2) sends a signal (d) to the controller (5) to turn OFF the switch (9) to a no-information zone (10) by the signal (i) from the controller (5).
j. The non-duplicated request would be allowed directly through the signal (I) into the host system from the processor (2).
k. Hardware specification storage unit (4) gathers and stores the hardware key form the host system (1) of the licensee by using the signal (b).

The following example is given by way of illustration only and should not be construed to limit the scope of the invention.

### EXAMPLE-1

An operating system was stored in the external memory of the device. Here the computer is the host system in which the operating system has to be installed. The computer allow only “Enter” keyboard button to access the operating system present in the external memory to be installed on to the computer, any other button or instructions from the keyboard generates “invalid button clicked” option on to the display thereby protecting the operating system present in the device. Hence duplication/coping of this operating system is negated. Also, there is an application programme stored in the hardware specification storage unit of the device that gathers the host information of the Ethernet card.

Following are the major advantages:
1. The electromechanical system of the present invention prevents copying of licensed operating system to a computer.
2. The system can be miniaturized to a chip configuration.
3. The electromechanical system integrated into a chip can be operated easily on any desktop, laptop, notebook and the like.
4. The electromechanical system can replace the CDs for installation/reinstallation of operating system.
5. The number of installations can be prefixed by the licenser according to market needs.

1.-7. (canceled)

8. A system for preventing unauthorized duplication of operating system software accessible on a computer, the system comprising:
a host computer standing alone or operationally connected to a network of computers, wherein the host computer stores user-desired operating system software or is dimensioned and configured to request user-desired operating system software disposed in a storage zone operationally connected to the network;
a hardware key stored on the host computer and transmissible over the network of the computers, wherein the hardware key uniquely identifies the host computer;
a storage zone operationally connected to the host computer or the network of computers and on which is stored the user-desired operating system software, wherein the storage zone is dimensioned and configured to duplicate the user-desired operating system software upon receipt of a permissible request to duplicate from the host computer;
a processor, a hardware specification storage unit, and a controller operationally connected to each other, and operationally interposed between and connected to the host computer and the software storage zone, and an instruction zone operationally connected to the processor;
a first switch operationally disposed between the hardware specification storage unit and the storage zone, wherein the first switch is configured to toggle between a first position wherein the hardware specification storage unit is operationally connected to the storage zone, and a second position wherein the hardware specification storage unit is operationally connected to a first no-information zone, wherein the first switch is operationally connected to the controller which is configured to toggle the first switch between the first and second positions;
a second switch operationally disposed between the processor and the storage zone, wherein the second switch is configured to toggle between a first position wherein the processor is operationally connected to the storage zone, and a second position wherein the processor is operationally connected to a second no-information zone, wherein the second switch is operationally connected to the controller which is configured to toggle the second switch between the first and second positions;
wherein the system is configured so that:
(a) when the host computer sends a request to duplicate the user-desired operating system from the storage zone, the hardware specification storage unit receives and stores the hardware key from the host computer and the processor compares the request from the host computer with a database of pre-set permissible requests stored in the instruction zone and if the request is permissible, the controller sets the first and second switches to their first positions, thereby forming an operational connection between the host computer and the storage zone, and if the request is impermissible, the controller sets the first switch to its second position, thereby connecting the host computer to the first no-information zone; and
(b) when the host computer sends a subsequent request to duplicate the user-desired operating system from the storage zone, the processor compares the request from the host computer with the database of pre-set permissible requests stored in the instruction zone and if the request is permissible, the controller sets the first and second switches to their first position, and if the request is impermissible, the controller sets the second switch to its second position, thereby connecting the host computer to the second no-information zone.

9. The system according to claim 8, wherein the host computer is selected from the group consisting of desktop computers, laptop computers, notebook computers and personal digital assistants (PDAs).

10. The system according to claim 8, wherein the processor, the hardware specification storage unit, the controller, the first switch, and the second switch are integrated on a single computer card.

11. The system according to claim 8, wherein the processor, the hardware specification storage unit, the controller, the first switch, and the second switch are integrated into a single chip.

12. The system according to claim 8, wherein the first switch, the second switch or both the first and second switches are mechanical switches.

13. The system according to claim 8, wherein the first switch, the second switch or both the first and second switches are electronic switches.

14. The system according to claim 8, wherein the processor, the hardware specification storage unit, the controller, the first switch, and the second switch are integrated into a micro electromechanical system (MEMS) chip.

15. The system according to claim 8, wherein the storage zone comprises a device selected from the group consisting of a memory flash, a memory flash card, a hard disk drive, random-access memory, erasable programmable read-only memory (EPROM), and electrically erasable programmable read-only memory (EEPROM).

16. A system for preventing unauthorized duplication of operating system software accessible on a computer, the system comprising:
a host computer standing alone or operationally connected to a network of computers, wherein the host computer stores user-desired operating system software or is dimensioned and configured to request user-desired operating system software disposed in a storage zone operationally connected to the network;
a hardware key stored on the host computer and transmissible over the network of the computers, wherein the hardware key uniquely identifies the host computer;
a storage zone operationally connected to the host computer or the network of computers and on which is stored the user-desired operating system software, wherein the storage zone is dimensioned and configured to duplicate the user-desired operating system software upon receipt of a permissible request to duplicate from the host computer;
a processor, a hardware specification storage unit, and a controller operationally connected to each other, and operationally interposed between and connected to the host computer and the software storage zone, and an instruction zone operationally connected to the processor;
a first switch operationally disposed between the hardware specification storage unit and the storage zone, wherein the first switch is configured to toggle between a first position wherein the hardware specification storage unit is operationally connected to the storage zone, and a second position wherein the hardware specification storage unit is operationally connected to a first no-information zone, wherein the first switch is operationally connected to the controller which is configured to toggle the first switch between the first and second positions;
a second switch operationally disposed between the processor and the storage zone, wherein the second switch is configured to toggle between a first position wherein the processor is operationally connected to the storage zone, and a second position wherein the processor is operationally connected to a second no-information zone, wherein the second switch is operationally connected to the controller which is configured to toggle the second switch between the first and second positions;
wherein the system is configured so that:
(a) when the host computer sends a request to duplicate the user-desired operating system from the storage zone, the hardware specification storage unit receives and stores the hardware key from the host computer and the processor compares the request from the host computer with a database of pre-set permissible requests stored in the instruction zone and if the request is permissible, the controller sets the first and second switches to their first positions, thereby forming an operational connection between the host computer and the storage zone, and if the request is impermissible, the controller sets the first switch to its second position, thereby connecting the host computer to the first no-information zone; and
(b) when the host computer sends a subsequent request to duplicate the user-desired operating system from the storage zone, the processor compares the request from the host computer with the database of pre-set permissible requests stored in the instruction zone and if the request is permissible, the controller sets the first and second switches to their first position, and if the request is impermissible, the controller sets the second switch to its second position, thereby connecting the host computer to the second no-information zone;
and wherein the processor, the hardware specification storage unit, the controller, the first switch, and the second switch are integrated into a micro electromechanical system (MEMS) chip.

17. The system according to claim 16, wherein the host computer is selected from the group consisting of desktop computers, laptop computers, notebook computers and personal digital assistants (PDAs).

18. The system according to claim 16, wherein the storage zone comprises a device selected from the group consisting of a memory flash, a memory flash card, a hard disk drive, random-access memory, erasable programmable read-only memory (EPROM), and electrically erasable programmable read-only memory (EEPROM).

19. A system for preventing unauthorized duplication of operating system software accessible on a computer, the system comprising:
a host computer standing alone or operationally connected to a network of computers, wherein the host computer stores user-desired operating system software or is dimensioned and configured to request user-desired operating system software disposed in a storage zone operationally connected to the network;
a hardware key stored on the host computer and transmissible over the network of the computers, wherein the hardware key uniquely identifies the host computer;
a storage zone operationally connected to the host computer or the network of computers and on which is stored the user-desired operating system software, wherein the storage zone is dimensioned and configured to duplicate the user-desired operating system software upon receipt of a permissible request to duplicate from the host computer;
a processor, a hardware specification storage unit, and a controller operationally connected to each other, and operationally interposed between and connected to the host computer and the software storage zone, and an instruction zone operationally connected to the processor;
a first switch operationally disposed between the hardware specification storage unit and the storage zone, wherein the first switch is configured to toggle between a first position wherein the hardware specification storage unit is operationally connected to the storage zone, and a second position wherein the hardware specification storage unit is operationally connected to a first no-information zone, wherein the first switch is operationally connected to the controller which is configured to toggle the first switch between the first and second positions;
a second switch operationally disposed between the processor and the storage zone, wherein the second switch is configured to toggle between a first position wherein the processor is operationally connected to the storage zone, and a second position wherein the processor is operationally connected to a second no-information zone, wherein the second switch is operationally connected to the controller which is configured to toggle the second switch between the first and second positions;
wherein the system is configured so that:
(a) when the host computer sends a request to duplicate the user-desired operating system from the storage zone, the hardware specification storage unit receives and stores the hardware key from the host computer and the processor compares the request from the host computer with a database of pre-set permissible requests stored in the instruction zone and if the request is permissible, the controller sets the first and second switches to their first positions, thereby forming an operational connection between the host computer and the storage zone, and if the request is impermissible, the controller sets the first switch to its second position, thereby connecting the host computer to the first no-information zone; and
(b) when the host computer sends a subsequent request to duplicate the user-desired operating system from the storage zone, the processor compares the request from the host computer with the database of pre-set permissible requests stored in the instruction zone and if the request is permissible, the controller sets the first and second switches to their first position, and if the request is impermissible, the controller sets the second switch to its second position, thereby connecting the host computer to the second no-information zone;
and wherein the processor, the hardware specification storage unit, the controller, the first switch, and the second switch are integrated into a single chip.

20. The system according to claim 19, wherein the host computer is selected from the group consisting of desktop computers, laptop computers, notebook computers and personal digital assistants (PDAs).

21. The system according to claim 19, wherein the first switch, the second switch or both the first and second switches are mechanical switches.

22. The system according to claim 19, wherein the first switch, the second switch or both the first and second switches are electronic switches.

23. The system according to claim 19, wherein the storage zone comprises a device selected from the group consisting of a memory flash, a memory flash card, a hard disk drive, random-access memory, erasable programmable read-only memory (EPROM), and electrically erasable programmable read-only memory (EEPROM).
